(19) United States
(12) Patent Application Publication
(10) Pub. No.: US 2007/0040783 A1
(43) Pub. Date: Feb. 22, 2007

(54) Liquid crystal display apparatus and method for driving liquid crystal display apparatus

(75) Inventors: Sachiko Kawada, Tokyo (JP); Takashi Akiyama, Sayama-shi (JP); Rintarou Takahashi, Tokorozawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: CITIZEN WATCH CO., LTD.

(21) Appl. No.: 11/504,654

(22) Filed: Aug. 16, 2006

(30) Foreign Application Priority Data
Aug. 16, 2005 (JP) 2005-235957

(51) Int. Cl. G09G 3/36

(52) U.S. Cl. 345/88

(57) ABSTRACT

An object of the invention is to provide a liquid crystal display apparatus, that achieves excellent color reproducibility with simple circuitry, and a method for driving such a liquid crystal display apparatus. The liquid crystal display apparatus includes a color light source, a liquid crystal display section for controlling transmission or reflection of light emitted from the color light source, a receiving section for receiving pixel data having red color data, green color data, and blue color data, a corrected data generating section for generating corrected red color data, corrected green color data, and corrected blue color data by using at least the red color data, the green color data, and the blue color data, and a liquid crystal driving section for driving the liquid crystal display section by using the corrected red color data, the corrected green color data, and the corrected blue color data.

This application is a new U.S. patent application that claims benefit of JP 2005-235957, filed on Aug. 16, 2005, the entire content of JP 2005-235957 being hereby incorporated by reference.

### FIELD OF THE INVENTION

The present invention relates to a liquid crystal display apparatus and a method for driving the liquid crystal display apparatus and, more particularly, relates to an FSC (Field Sequential Color) liquid crystal display apparatus and a method for driving the same.

### BACKGROUND OF THE INVENTION

In an FSC liquid crystal display apparatus, the period (one field) for displaying one color image (one frame) on the liquid crystal display screen is divided into an R-subfield for displaying a red color image, a G-subfield for displaying a green color image, and a B-subfield for displaying a blue color image, and the desired color image is produced by successively displaying the respective color images in the respective subfields. The liquid crystal display screen comprises a plurality of scanning electrodes and signal electrodes arranged in a matrix array.

In the FSC liquid crystal display apparatus, in the R-subfield period all the liquid crystal pixels on the screen are driven based on the pixel data corresponding to red color and, subsequently, red color light is emitted to display the image in red. Likewise, the green color image is displayed in the G-subfield period and the blue color image is displayed in the B-subfield period. In the FSC liquid crystal display apparatus, the red, green, and blue color images are presented for display by switching from one image to another at a rate faster than the human eye can perceive, thereby causing the separate images to be perceived as one full-color image (one frame) by the human eye.

Here, if attention is paid to one particular liquid crystal pixel, the pixel is driven first based on the pixel data corresponding to red color, next based on the pixel data corresponding to green color, and finally based on the pixel data corresponding to blue color; only then can the liquid crystal pixel be displayed in the color intended for that pixel.

FIG. 5(a) is a diagram showing the transient response of the transmittance of light in one particular liquid crystal pixel, and FIG. 5(b) is a diagram for explaining a drive voltage applied to the liquid crystal.

In FIG. 5, a normally white liquid crystal panel is used whose transmittance of light is 100% when no voltage is applied to the liquid crystal. In FIG. 5(a), the vertical axis represents the light transmittance T (%) of the liquid crystal pixel, and the horizontal axis represents the elapsed time t (sec). The liquid crystal used in the liquid crystal screen generally has the characteristic that, because of its slow response, if each liquid crystal pixel is driven based on its pixel data, it takes a finite time for the liquid crystal pixel to reach its intended light transmittance. For example, suppose that when the light transmittance of a liquid crystal pixel s1 is held at 0%, a voltage that causes the light transmittance of that pixel to increase to 100% is applied at t=t1′. In this case, as shown by a curve 501, the light transmittance begins to change starting at t1′ and reaches the intended light transmittance (100%) at t=t2′.

On the other hand, suppose that the pixel s1 had been driven and its light transmittance is held at 50% until just before the voltage that causes the light transmittance of that pixel to increase to 100% was applied at t=t1′ (see FIG. 5(b)). In this case, as shown by a curve 502, the light transmittance begins to change starting at t=t1′ and reaches the intended light transmittance (100%) at t=t3′ which is earlier than in the case of the curve 501.

As the transient response characteristic of the liquid crystal pixel varies depending on its immediately previous driving state, etc. as described above, if the liquid crystal pixel is always driven with the same condition regardless of its immediately previous driving state, there arises the problem that the pixel may be displayed differently depending on its immediately previous driving state, resulting in an inability to reproduce the initially intended color. If provisions are made to produce the display after a sufficient time has elapsed (for example, at t=t4′) allowing the light transmittance of the liquid crystal pixel to stabilize, it may not be necessary to consider the variation of the transient response characteristic of the liquid crystal pixel. However, in the case of the FSC liquid crystal display apparatus in particular, the red, green, and blue color images must be sequentially and repeatedly displayed with very early timing (for example, at t=t5′). Accordingly, such transient response characteristics of liquid crystal pixels have been a major factor deteriorating the color reproducibility of the FSC liquid crystal display apparatus.

In view of the above, an attempt has been made to improve the color reproducibility by storing at least the previous pixel data for each liquid crystal pixel and by correcting, using the previous pixel data, the current pixel data to be used to drive the liquid crystal pixel (for example, refer to patent document 1).

However, if such a correction is to be made, a plurality of frame memories for comparison and correction purposes have to be provided in order to store the pixel data for at least the immediately previous frame (one image frame) and the pixel data for the current frame (one image frame). The provision of such a plurality of frame memories leads to the problem of increased memory capacity and, hence, an increased cost and an increased size of the apparatus. This problem becomes more pronounced as the size of, or the number of pixels in, the liquid crystal display screen increases.

Furthermore, since a comparison has to be made between the previous pixel data and the current pixel data for each pixel within a predefined time, the speed of the calculating unit has to be increased, which necessarily increases the cost or the amount of circuitry involved.

Patent document 1: JP-A-H07-56143 (FIG. 1)

### SUMMARY OF THE INVENTION

Accordingly, it is an object of the present invention to provide a liquid crystal display apparatus that achieves excellent color reproducibility with simple circuitry or a simple circuit system configuration, and a method for driving such a liquid crystal display apparatus.

A liquid crystal display apparatus according to the present invention includes a color light source, a liquid crystal display section having a plurality of pixels for controlling transmission or reflection of light emitted from the color light source, a receiving section for receiving pixel data having red color data, green color data, and blue color data corresponding to at least a designated one of the plurality of pixels, a corrected data generating section for generating corrected red color data, corrected green color data, and corrected blue color data using the red color data, the green color data, and the blue color data, and a liquid crystal driving section for driving the designated one pixel in the liquid crystal display section by using the corrected red color data, the corrected green color data, and the corrected blue color data. Here, as the pixel data composed of red color data, green color data, and blue color data for any particular pixel is corrected by using the pixel data itself, there is no need to hold the pixel data used to drive that particular pixel in the previous frame.

Preferably, in the liquid crystal display apparatus according to the present invention, the color light source includes a red light source for emitting red color light, a green light source for emitting green color light, and a blue light source for emitting blue color light, and the liquid crystal display apparatus further includes a control section for performing control to display the designated one pixel by displaying a red color image with the red color light emitted from the red light source while driving the liquid crystal display section based on the corrected red color data, by displaying a green color image with the green color light emitted from the green light source while driving the liquid crystal display section based on the corrected green color data, and by displaying a blue color image with the blue color light emitted from the blue light source while driving the liquid crystal display section based on the corrected blue color data.

Further preferably, in the liquid crystal display apparatus according to the present invention, the corrected data generating section generates the corrected red color data by using at least the red color data, the green color data, and the blue color data, generates the corrected green color data by using at least the red color data, the green color data, and the blue color data, and generates the corrected blue color data by using at least the red color data, the green color data, and the blue color data.

Further preferably, in the liquid crystal display apparatus according to the present invention, the corrected data generating section generates the corrected red color data, the corrected green color data, and the corrected blue color data by changing a method of correction according to grayscale data representing grayscale levels of the red color data, the green color data, and the blue color data. The grayscale data is divided, for example, in three ranges according to the grayscale levels so that the correction can be made with greater accuracy.

Further preferably, in the liquid crystal display apparatus according to the present invention, the corrected data generating section changes the method of correction according to the grayscale data by dividing the grayscale data into a plurality of ranges according to the grayscale levels, and preferably the corrected red color data, the corrected green color data, and the corrected blue color data are generated using correction equations predetermined for each of the plurality of ranges into which the grayscale data has been divided according to the grayscale levels.

Preferably, the liquid crystal display apparatus according to the present invention further comprises a buffer memory for storing the red color data, green color data, and blue color data received by the receiving section only for the designated one pixel, and for sending the stored color data to the corrected data generating section.

Also preferably, the liquid crystal display apparatus according to the present invention further comprises a frame memory for temporarily storing the corrected red color data, the corrected green color data, and the corrected blue color data.

Preferably, the liquid crystal display apparatus according to the present invention further comprises a temperature sensor disposed near the liquid crystal display section, and the corrected data generating section generates the corrected red color data, the corrected green color data, and the corrected blue color data by also using a temperature detection signal supplied from the temperature sensor.

Further preferably, in the liquid crystal display apparatus according to the present invention, the corrected data generating section generates the corrected red color data, the corrected green color data, and the corrected blue color data by also using the pixel data of liquid crystal pixels located around the liquid crystal pixel corresponding to the received red color data, green color data, and blue color data.

A liquid crystal display apparatus according to the present invention includes a color light source, a liquid crystal display section having a plurality of pixels for controlling transmission or reflection of light emitted from the color light source, a receiving section for receiving pixel data having continuously adjacent first color data, second color data, and third color data corresponding to at least a designated one of the plurality of pixels, a corrected data generating section for generating corrected first color data, corrected second color data, and corrected third color data by using at least one of the first color data, the second color data, and the third color data; and a liquid crystal driving section for driving the designated one pixel in the liquid crystal display section by using the corrected first color data, the corrected second color data, and the corrected third color data. Here, as the pixel data composed of first color data, second color data, and third color data for any particular pixel is corrected by using the pixel data itself, there is no need to hold the pixel data used to drive that particular pixel in the previous frame.

Preferably, in the liquid crystal display apparatus according to the present invention, the color light source includes a first light source for emitting first color light, a second light source for emitting second color light, and a third light source for emitting third color light, and the liquid crystal display apparatus further comprises a control section for performing control to display the designated one pixel by displaying a first color image with the first color light emitted from the first light source while driving the liquid crystal display section based on the corrected first color data, by displaying a second color image with the second color light emitted from the second light source while driving the liquid crystal display section based on the corrected second color data, and by displaying a third color image with the third color light emitted from the third light source while driving the liquid crystal display section based on the corrected third color data.

Further preferably, in the liquid crystal display apparatus according to the present invention, the corrected data generating section generates the corrected first color data by correcting the first color data by using at least one of the first color data, the second color data, and the third color data, generates the corrected second color data correcting the second color data by using at least one of the first color data, the second color data, and the third color data, and generates the corrected third color data by correcting the third color data by using at least one of the first color data, the second color data, and the third color data.

Further preferably, in the liquid crystal display apparatus according to the present invention, the corrected data generating section generates the corrected first color data, the corrected second color data, and the corrected third color data by changing a method of correction according to grayscale data representing grayscale levels of the first color data, the second color data, and the third color data. The grayscale data is divided, for example, in three ranges according to the grayscale levels so that the correction can be made with greater accuracy.

Further preferably, in the liquid crystal display apparatus according to the present invention, the corrected data generating section changes the method of correction according to the grayscale data by dividing the grayscale data into a plurality of ranges according to the grayscale levels, and preferably the corrected first color data, the corrected second color data, and the corrected third color data are generated using correction equations predetermined for each of the plurality of ranges into which the grayscale data has been divided according to the grayscale levels.

Preferably, the liquid crystal display apparatus according to the present invention further comprises a buffer memory for storing only the continuously adjacent first color data, second color data, and third color data received by the receiving section, and for sending the stored color data to the corrected data generating section.

Also preferably, the liquid crystal display apparatus according to the present invention further comprises a frame memory for temporarily storing the corrected first color data, the corrected second color data, and the corrected third color data.

A method for driving a liquid crystal display apparatus according to the present invention includes the steps of receiving a plurality of contiguous component data corresponding to at least a designated one of a plurality of pixels, generating a plurality of corrected component data by only using the plurality of component data, and driving the designated one pixel in a liquid crystal display section by using the plurality of corrected component data.

In the liquid crystal display apparatus according to the present invention, as there is no need to provide a plurality of frame memories for comparison and correction purposes, the required memory capacity and hence the cost can be reduced.

Furthermore, in the liquid crystal display apparatus according to the present invention, as the pixel data for any particular pixel is corrected by using the pixel data of the particular pixel itself, the correction can be made at high speed using a simple calculating unit.

### BRIEF DESCRIPTION OF THE DRAWINGS

These and other features and advantages of the present invention will be better understood by reading the following detailed description, taken together with the drawings wherein:

FIG. 1 is a diagram showing the basic configuration of a liquid crystal display apparatus according to the present invention;

FIG. 2 is a diagram for explaining the operation of a liquid crystal display section in FIG. 1;

FIG. 3 is a diagram showing one example of a timing for operating the liquid crystal display section;

FIG. 4 is a diagram for explaining the flow of pixel data for the liquid crystal display apparatus according to the present invention; and

FIG. 5(a) is a diagram showing the transient response characteristic of the transmittance of light in a liquid crystal, and FIG. 5(b) is a diagram for explaining a drive voltage applied to the liquid crystal.

### DETAILED DESCRIPTION OF THE PREFERRED EMBODIMENT

A liquid crystal display apparatus and a method for driving a liquid crystal display apparatus according to the present invention will be described below with reference to the drawings. It should, however, be understood that the present invention is not limited to any specific embodiment described herein or illustrated in the drawings.

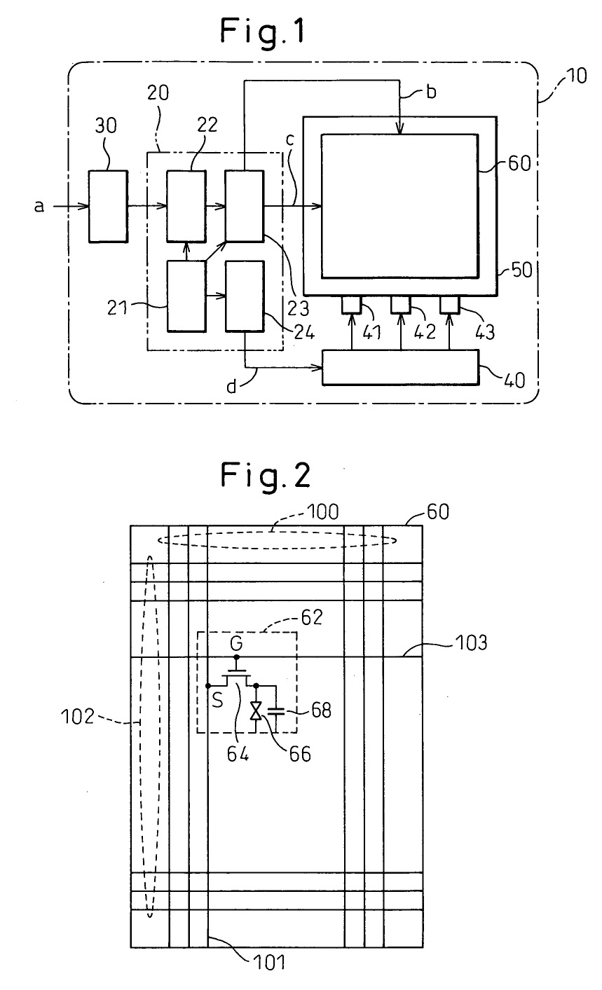

FIG. 1 is a diagram showing the basic configuration of the liquid crystal display apparatus 10 according to the present invention.

The liquid crystal display apparatus 10 includes a control section 20, an IF section 30, an LED driving section 40, a red LED 41, a green LED 42, a blue LED 43, a light guiding plate 50, a liquid crystal display section 60, etc. and functions as an FSC liquid crystal display apparatus.

The control section 20 includes a control unit 21 comprising a CPU, etc., a calculating section 22 for correcting pixel data “a” in order to enhance the color reproducibility of the liquid crystal display section 60, a liquid crystal driving section 23 for driving the liquid crystal display section 60, and a timing signal generating section 24 for generating a timing signal “d” for synchronizing the flash timing of each LED with the driving of the liquid crystal display section 60.

The control unit 21 receives via the IF section 30 the pixel data “a” supplied, for example, from a control section of a portable telephone and, after correcting the received pixel data “a” by the pixel data calculating section 22, performs control so that the liquid crystal display section 60 is driven by the liquid crystal driving section 23 based on the corrected pixel data. The control unit 21 also performs control so that the timing signal “d” for driving each LED in synchronism with the driving by the liquid crystal driving section 23 is generated by the timing signal generating section 24 and supplied to the LED driving section 40.

The liquid crystal driving section 23 drives the liquid crystal pixels in the liquid crystal display section 60 in sequence by supplying a data signal “b” to each of a plurality of signal electrodes and a scanning signal “c” to each of a plurality of scanning electrodes in the liquid crystal display section 60.

The LED driving section 40 emittes the red LED 41, the green LED 42, and the blue LED 43 in sequence by driving them in accordance with the timing signal “d”.

The red LED 41, the green LED 42, and the blue LED 43 are optically coupled to the light guiding plate 50, the construction being such that when each LED is emitted, the entire liquid crystal display section 60 is illuminated via the light guiding plate by the colored light emitted from the LED.

In the present embodiment, the liquid crystal display section 60 includes top and bottom substrates made of glass and a liquid crystal sandwiched between the top and bottom substrates and sealed by a sealing material, and functions as a so-called active liquid crystal panel. The liquid crystal display section 60 also includes 131 signal electrodes and 160 scanning electrodes arranged in a matrix array, and pixel electrodes are formed where the signal and scanning electrodes intersect so that the light transmittance of each individual liquid crystal pixel can be controlled. Devices such as TFTs, MiMs, or TFDs can be used as the active devices for driving the liquid crystal.

In the present embodiment, a TN liquid crystal is used as the liquid crystal in the liquid crystal display apparatus 10, but other liquid crystals, such as an STN liquid crystal, can also be used. Use can also be made of ferroelectric liquid crystal, antiferroelectric liquid crystal, OCB (Optically Compensated Birefringence) liquid crystal, vertically aligned liquid crystal, IPS (In-Plane Switching) liquid crystal (panel), etc. Further, any of these liquid crystals can be constructed as a passive liquid crystal panel, a static liquid crystal panel, or an active liquid crystal panel to which the present invention is applied. In such cases also, the effect of the invention can be achieved.

FIG. 2 is a diagram for explaining the operation of the liquid crystal display section 60 that functions as an active matrix liquid crystal panel.

In FIG. 2, one pixel 62 is shown which is located at the intersection between a particular signal electrode 101 in the signal electrode group 100 and a particular scanning electrode 103 in the scanning electrode group 102 in the liquid crystal display section 60. The pixel 62 includes a transistor 64, a liquid crystal pixel 66, and a capacitor 68. The gate electrode G of the transistor 64 is connected to the scanning electrode 103. When the scanning electrode is scanned and the transistor 64 conducts, pixel data corresponding to the signal electrode connected to the source electrode S is stored into the capacitor 68. The liquid crystal pixel 66 is driven by the voltage stored in the capacitor 68, causing its light transmittance to change. Here, the liquid crystal pixel 66 can retain the state corresponding to the pixel data for a prescribed period of time by the action of the capacitor 68.

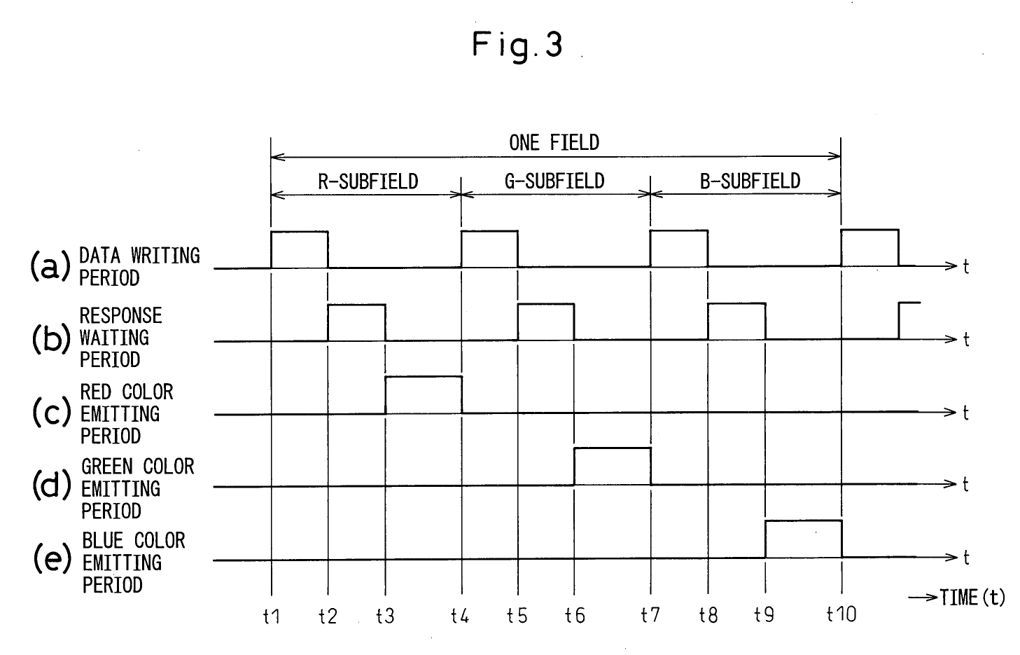

FIG. 3 is a diagram showing one example of timing for driving the liquid crystal display section 60.

In part (a) of FIG. 3, the intervals from t1 to t2, from t4 to t5, and from t7 to t8 each indicate the time interval during which the pixel data for one image plane is written to all the pixels in the liquid crystal display section 60 (t1 to t2 for a red image plane, t4 to t5 for a green image plane, and t7 to t8 for a blue image plane). That is, the intervals from t1 to t2, from t4 to t5, and from t7 to t8 are each equal to the period during which the scanning signal is sequentially applied to all the 160 scanning electrodes 102. Part (b) of FIG. 3 shows the waiting period that is provide to wait until all the pixels in the liquid crystal display section 60 reach the light transmittances defined by their pixel data. Part (c) of FIG. 3 shows the period during which the red LED 41 is emitted light, part (d) of FIG. 3 shows the period during which the green LED 42 is emitted light, and part (e) of FIG. 3 shows the period during which the blue LED is emitted light.

In FIG. 3, one field refers to the period for displaying each liquid crystal pixel in its intended color by emitting the red, green, and blue LEDs sequentially by driving the liquid crystal display section 60 in time-division drive. One field is made up of three equal subfields, an R-subfield, a G-subfield, and a B-subfield. An image for one frame is displayed in one field. Usually, the duration of one field is about 16.67 ms, and the duration of each of the three subfields into which one field is equally divided is about 5.56 ms.

As shown in FIG. 3, the writing of the red color data starts at t=t1 and ends at t=t2 and, at t=t3, the liquid crystal pixel connected to the last selected scanning electrode reaches the light transmittance defined by its red color data, so that the red LED 41 is emitted light during the period t=t3 to t=t4 to display the red color image. Likewise, the writing of the green color data starts at t=t4 and ends at t=t5 and, at t=t6, the liquid crystal pixel connected to the last selected scanning electrode reaches the light transmittance defined by its green color data, so that the green LED 42 is emitted light during the period t=t6 to t=t7 to display the green color image. Further, the writing of the blue color data starts at t=t7 and ends at t=t8 and, at t=t9, the liquid crystal pixel connected to the last selected scanning electrode reaches the light transmittance defined by its blue color data, so that the blue LED 43 is emitted light during the period t=t9 to t=t10 to display the blue color image.

In this way, the red, green, and blue color images are sequentially displayed to complete one image frame. By displaying the image from one frame to another on the liquid crystal display section 60 in like manner, the desired image can be presented for viewing by the user.

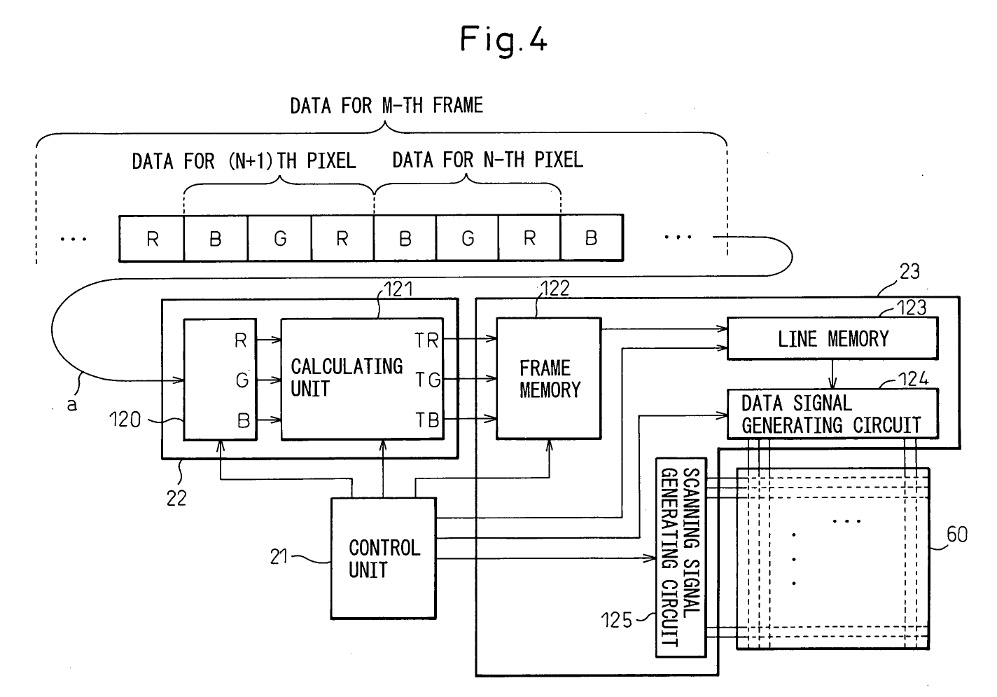

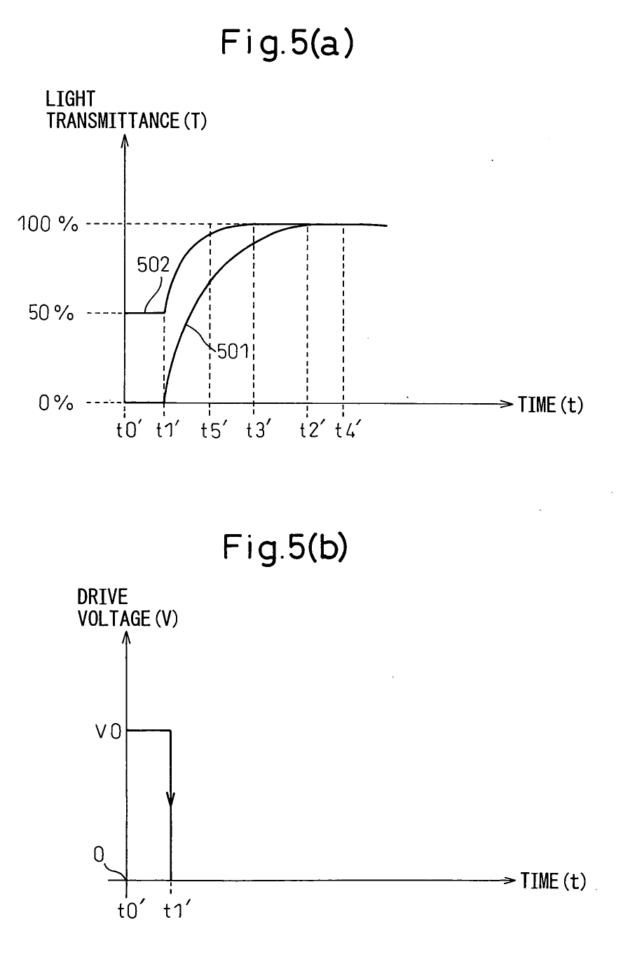

FIG. 4 is a diagram for explaining the flow of pixel data in the liquid crystal display apparatus according to the present invention.

As shown in FIG. 4, the pixel data “a” is a data sequence in which red, green, and blue color data (see R, G, and B in FIG. 4), six bits for each color, are continued in series from one pixel to another. Data for all the pixels (160×131=20960 pixels) of the liquid crystal display section 60 together constitute the pixel data for one frame. Here, the order of the continued red, green, and blue data need not necessarily be limited to the order of R, G, and B.

Further, as shown in FIG. 4, the calculating section 22 includes a one-pixel memory 120 and a calculated unit 121. The liquid crystal driving section 23 includes a frame memory 122 capable of temporarily storing the corrected red, green, and blue color data (TR, TG, and TB) on a pixel-by-pixel basis for all the pixels (160×131=20960 pixels) of the liquid crystal display section 60, a line memory 123 capable of storing the pixel data for one line (160 pixels) for a designated one of the red, green, and blue colors; a data signal generating circuit 124; and a scanning signal generating circuit 125. The memory 120 includes a serial-parallel conversion circuit. The memory 120 need only have a storage capacity sufficient to buffer the data for one pixel, i.e., the red, green, and blue color data, but the storage capacity need not be limited to the data for one pixel, and a suitable memory that is inexpensive and that has a sufficiently small capacity can be used as the memory 120. The frame memory 122 is a memory necessary for transmitting display data to the display panel, and preferably comprises an R-subframe memory for red color data, a G-subframe memory for green color data, and a B-subframe memory for blue color data. The configuration shown in FIG. 4 eliminates the need for providing, in front of the frame memory 121, an additional frame memory for storing the previous pixel data.

The control unit 21 performs control so that the corrected red, green, and blue color data (TR, TG, and TB) received for each pixel from the calculating unit 121 are temporarily stored in the frame memory 122 and so that the corrected pixel data stored in the frame memory 122 are output on a line-by-line basis to the line memory 123. Further, the control unit 21 performs control so that the scanning signal is output from the scanning signal generating circuit 125 and applied to each of the 160 scanning electrodes 102 in sequence while, on the other hand, the data signals corresponding to the corrected pixel data are output from the data signal generating circuit 124 and applied to all the 131 data signal electrodes 100 at the same time with the scanning signal.

Next, correction equations used to correct the respective color data will be described below.

In the present embodiment, the correction equations are applied in three steps according to the grayscale level (luminance level) of the pixel data for each color, and the corrected color data (TR, TG, and TB) are obtained from the uncorrected color data (R, G, and B) by using the correction equations corresponding to each level. As each color data comprises 6-bit grayscale data as earlier mentioned, the grayscale data lies within the range of levels 63 to 0. In the present embodiment, the high grayscale levels of 63 to 60 are chosen as the first step, the middle grayscale levels of 59 to 15 are chosen as the second step, and the low grayscale levels of 14 to 0 are chosen as the third step. The reason for the division into such a plurality of steps is that an image of better color reproducibility can be obtained by applying the correction equations according to the respective grayscale levels. However, the correction equations may be applied without dividing the process into a plurality of steps. Further, the grayscale levels and the division into three steps described above are only examples, and other grayscale levels may be chosen, or the correction equations may be set by dividing the process into four or more steps.

In the present embodiment, since provisions are made to apply the correction equations in three steps as shown below, the scale of circuitry does not increase, proper corrections can be made at low cost, and the display quality improves. Here, it is preferable that the number of steps to be determined according to the grayscale data be determined by considering the characteristics of the light transmittance response to the driving of the liquid crystal and the amount of circuitry required of the correction circuit system and the calculating unit.

In the first step when the grayscale level is in the range of 63 to 60:
TR=a1R+b1G+c1B+OFS1 (1)
TG=a2R+b2G+c2B+OFS2 (2)
TB=a3R+b3G+c3B+OFS3 (3)

In the second step when the grayscale level is in the range of 59 to 15:
TR=a4R+b4G+c4B+OFS4 (4)
TG=a5R+b5G+c5B+OFS5 (5)
TB=a6R+b6G+c6B+OFS6 (6)

In the third step when the grayscale level is in the range of 14 to 0:
TR=a7R+b7G+c7B+OFS7 (7)
TG=a8R+b8G+c8B+OFS8 (8)
TB=a9R+b9G+c9B+OFS9 (9)

In the above correction equations (1) to (9), the constants a1 to a9, b1 to b9, c1 to c9, and OFS1 to OFS9 are determined by conducting experiments and measuring the characteristics of the liquid crystal, and are preset in the calculating unit 121. Further, any one of the constants a1 to a9, b1 to b9, c1 to c9, and OFS1 to OFS9 may be set to “0”.

The correction equations (1) to (9) are shown below using examples of the constants obtained by conducting experiments and measuring the characteristics of the liquid crystal.

In the first step for the grayscale levels of 63 to 60:
TR=(56/64)×R+(2/64)×G+(−4/64)×B+(3/64) (1)
TG=(−4/64)×R+(56/64)×G+(2/64)×B+(3/64) (2)
TB=(2/64)×R+(−4/64)×G+(56/64)×B+(3/64) (3)

In the second step for the grayscale levels of 59 to 15:
TR=(60/64)×R+(0)×G+(2/64)×B+(2/64) (4)
TG=(2/64)×R+(60/64)×G+(0)×B+(2/64) (5)
TB=(0)×R+(2/64)×G+(60/64)×B+(2/64) (6)

In the third step for the grayscale levels of 14 to 0:
TR=(63/64)×R+(0)×G+(0)×B+(1/64) (7)
TG=(0)×R+(63/64)×G+(0)×B+(1/64) (8)
TB=(0)×R+(0)×G+(63/64)×B+(1/64) (9)

Here, TR, TG, and TB are the data for the respective colors corrected using the correction equations. R, G, and B are the data for the respective colors before correction.

In the present invention, the pixel data for each pixel is corrected based only on its own pixel data, not by comparison with the pixel data one frame back. This is because, in the FSC liquid crystal display apparatus, each particular liquid crystal pixel is driven first, for example, based on the red color data in its own pixel data, next based on the green color data in its own pixel data, and finally based on the blue color data in its own pixel data. When driving the liquid crystal pixel based on the green color data and blue color data, respectively, the previous driving state of the liquid crystal pixel can be judged based on the pixel data for that liquid crystal pixel. On the other hand, when driving the liquid crystal pixel based on the red color data, the blue color data in the preceding frame must be referred to. However, as the color displayed by each particular pixel has high correlation with the color displayed in the preceding frame (the probability of displaying a color having no relevance to that displayed in the preceding frame is low), how the liquid crystal pixel was driven in the preceding frame can be empirically predicted to a certain extent from the red, green, and blue colors. Accordingly, in the present invention, control is performed so that the pixel data for each pixel is corrected based on its own pixel data, not based on the pixel data one frame back. The prior art circuit has required the provision of a memory for one frame or for at least one subframe rather than a memory for one pixel such as the one-pixel memory 120 shown in FIG. 4, but in the present embodiment, as control is performed so that the pixel data for each pixel is corrected based on its own pixel data, there is no need to provide a memory for one frame or for at least one subframe.

In the FSC liquid crystal display apparatus described above, control has been performed to display the red, green, and blue color images by driving the liquid crystal display section 14 in time-division drive. That is, the component data for each pixel comprises the red color data, the green color data, and the blue color data. However, the present invention is not limited to these component data, but component data other than red, green, and blue can also be handled. For example, yellow color data, magenta color data, and cyan color data may be used as the component data for each pixel. Further, the component data is not limited to three kinds of color data, but two or four or more kinds of color data may be used.

The present invention can also be applied to a liquid crystal having a large temperature dependence (a liquid crystal whose characteristics greatly changes depending on the ambient temperature and its own temperature). In the case of a liquid crystal having a large temperature dependence, color reproducibility can change due to changes in ambient temperature. In this case, a temperature sensor is installed near the periphery of the liquid crystal display section 60, and control can be performed in such a manner as to cancel the effects of the ambient temperature by varying OFS1 to OFS9 in accordance with the temperature detection signal supplied from the temperature sensor.

What is claimed is:

1. A liquid crystal display apparatus, comprising:
a color light source;
a liquid crystal display section having a plurality of pixels for controlling transmission or reflection of light emitted from said color light source;
a receiving section for receiving pixel data having red color data, green color data, and blue color data corresponding to at least a designated one of said plurality of pixels;
a corrected data generating section for generating corrected red color data, corrected green color data, and corrected blue color data by using said red color data, said green color data, and said blue color data; and
a liquid crystal driving section for driving said designated one pixel in said liquid crystal display section by using said corrected red color data, said corrected green color data, and said corrected blue color data.

2. The liquid crystal display apparatus according to claim 1, wherein said color light source includes a red light source for emitting red color light, a green light source for emitting green color light, and a blue light source for emitting blue color light, and further comprising a control section for performing control to display said designated one pixel by displaying a red color image with said red color light emitted from said red light source while driving said liquid crystal display section based on said corrected red color data, by displaying a green color image with said green color light emitted from said green light source while driving said liquid crystal display section based on said corrected green color data, and by displaying a blue color image with said blue color light emitted from said blue light source while driving said liquid crystal display section based on said corrected blue color data.

3. The liquid crystal display apparatus according to claim 2, wherein said corrected data generating section generates said corrected red color data, correcting said red color data, by using at least said red color data, said green color data, and said blue color data, generates said corrected green color data correcting said green color data by using at least said red color data, said green color data, and said blue color data, and generates said corrected blue color data correcting said blue color data by using at least said red color data, said green color data, and said blue color data.

4. The liquid crystal display apparatus according to claim 3, wherein said corrected data generating section generates said corrected red color data, said corrected green color data, and said corrected blue color data by changing a method of correction according to grayscale data representing grayscale levels of said red color data, said green color data, and said blue color data.

5. The liquid crystal display apparatus according to claim 4, wherein said corrected data generating section changes the method of correction according to said grayscale data by dividing said grayscale data into a plurality of ranges according to said grayscale levels.

6. The liquid crystal display apparatus according to claim 5, wherein said corrected red color data, said corrected green color data, and said corrected blue color data are generated using correction equations predetermined for each of said plurality of ranges into which said grayscale data has been divided according to said grayscale levels.

7. The liquid crystal display apparatus according to claim 1, further comprising a buffer memory for storing said red color data, green color data, and blue color data received by said receiving section only for said designated one pixel, and for sending said stored color data to said corrected data generating section.

8. The liquid crystal display apparatus according to claim 1, further comprising a frame memory for temporarily storing said corrected red color data, said corrected green color data, and said corrected blue color data.

9. A liquid crystal display apparatus, comprising:
a color light source;
a liquid crystal display section having a plurality of pixels for controlling transmission or reflection of light emitted from said color light source;
a receiving section for receiving pixel data having continuously adjacent first color data, second color data, and third color data corresponding to at least a designated one of said plurality of pixels;
a corrected data generating section for generating corrected first color data, corrected second color data, and corrected third color data by using at least one of said first color data, said second color data, and said blue color data; and
a liquid crystal driving section for driving said designated one pixel in said liquid crystal display section by using said corrected first color data, said corrected second color data, and said corrected third color data.

10. The liquid crystal display apparatus according to claim 9, wherein said color light source includes a first light source for emitting first color light, a second light source for emitting second color light, and a third light source for emitting third color light, and further comprising a control section for performing control to display said designated one pixel by displaying a first color image with said first color light emitted from said first light source while driving said liquid crystal display section based on said corrected first color data, by displaying a second color image with said second color light emitted from said second light source while driving said liquid crystal display section based on said corrected second color data, and by displaying a third color image with said third color light emitted from said third light source while driving said liquid crystal display section based on said corrected third color data.

11. The liquid crystal display apparatus according to claim 10, wherein said corrected data generating section generates said corrected first color data correcting said first color data by using at least one of said first color data, said second color data, and said third color data, generates said corrected second color data correcting said second color data by using at least one of said first color data, said second color data, and said third color data, and generates said corrected third color data correcting said third color data by using at least one of said first color data, said second first color color data, and said third color data.

12. The liquid crystal display apparatus according to claim 11, wherein said corrected data generating section generates said corrected first color data, said corrected second color data, and said corrected third color data by changing a method of correction according to grayscale data representing grayscale levels of said first color data, said second color data, and said third color data.

13. The liquid crystal display apparatus according to claim 12, wherein said corrected data generating section changes the method of correction according to said grayscale data by dividing said grayscale data into a plurality of ranges according to said grayscale levels.

14. The liquid crystal display apparatus according to claim 13, wherein said corrected first color data, said corrected second color data, and said corrected third color data are generated using correction equations predetermined for each of said plurality of ranges into which said grayscale data has been divided according to said grayscale levels.

15. The liquid crystal display apparatus according to claim 9, further comprising a buffer memory for storing only said continuously adjacent first color data, second color data, and third color data received by said receiving section, and for sending said stored color data to said corrected data generating section.

16. The liquid crystal display apparatus according to claim 9, further comprising a frame memory for temporarily storing said corrected first color data, said corrected second color data, and said corrected third color data.

17. A liquid crystal display apparatus, comprising:
a color light source;
a liquid crystal display section having a plurality of pixels for controlling transmission or reflection of light emitted from said color light source;
a receiving section for receiving a plurality of contiguous component data corresponding to at least a designated one of said plurality of pixels;
a corrected data generating section for generating a plurality of corrected component data by only using said plurality of component data; and
a liquid crystal driving section for driving said designated one pixel in said liquid crystal display section by using said plurality of corrected component data.

18. The liquid crystal display apparatus according to claim 17, wherein said plurality of component data has first color data, second color data, and third color data.

19. The liquid crystal display apparatus according to claim 18, wherein said first color data is red color data, said second color data is green color data, and said third color data is blue color data.

20. The liquid crystal display apparatus according to claim 19, wherein said corrected data generating section generates said corrected red color data correcting said red color data by using said red color data, said green color data, or said blue color data, generates said corrected green color data correcting said green color data by using said red color data, said green color data, or said blue color data, and generates said corrected blue color data correcting said blue color data by using said red color data, said green color data, or said blue color data.

21. A method for driving a liquid crystal display apparatus including a light source and a liquid crystal display section having a plurality of pixels for controlling transmission or reflection of light emitted from said color light source, the method comprising the steps of:
receiving a plurality of contiguous component data corresponding to at least a designated one of said plurality of pixels;
generating a plurality of corrected component data by only using said plurality of component data; and
driving said designated one pixel in said liquid crystal display section by using said plurality of corrected component data.
